(19) United States
(12) Patent Application Publication
(10) Pub. No.: US 2011/0031171 A1
(43) Pub. Date: Feb. 10, 2011

(54) Solar Powered Utility Unit

(76) Inventor: Yitzhak Henig, Ann Arbor, MI (US)

Correspondence Address: YITZHAK I. HENIG, 3417 S. ZEEB Rd., ANN ARBOR, MI, 48103, US

(21) Appl. No.: 12/848,989

(22) Filed: Aug. 2, 2010

Related U.S. Application Data
(60) Provisional application No. 61/232,403, filed on Aug. 7, 2009.

(51) Int. Cl. C02F 1/32; B01D 35/157; B01D 35/14; H01M 10/46

(52) U.S. Cl. 210/85; 210/137; 210/103; 210/252; 210/205; 320/101

(57) ABSTRACT

A solar power utility unit is disclosed that collects solar power during the day; stores the power in a battery pack; and distributes the energy stored in the battery to one or more utilities. The utilities can include a water purification system using a UV lamp, lights, AC electrical power to charge electronic devices, and a refrigerator. The utility unit has an electronic control unit to manage the electrical energy stored in the battery. The utilities can be ranked in priority and power turned off to lower priority utilities to ensure that the highest priority utility is serviced. Water purification system may be a continuous process with the water circulated by an electric pump, a batch process with the water transported by intermittent use of the electric pump, or a gravity feed process with valves to control the flow in and out of the purifier.

### CROSS-REFERENCE TO RELATED APPLICATIONS

The present application claims priority from U.S. Provisional Application No. 61/232,403 filed on Aug. 7, 2009 the entirety of which is incorporated herein by reference.

### FIELD

The present development relates to a utility unit having a water purifier and/or other utilities that are powered by solar energy.

### BACKGROUND AND SUMMARY

In remote, underserved, and unstable regions of the world, obtaining access to clean drinking water and a modest amount of electricity is uncertain, at best. To provide utility services in such locations in which an electrical grid is unavailable or intermittent, a solar-powered utility unit is disclosed. The utility unit has a solar collector coupled to a battery for charging during times of insolation (solar radiation received on a surface). The utility unit also has a water purification circuit including a water tank, an electric pump, and a purification section with a UV lamp. An electronic control unit controls the pump to circulate the water into the purification section where a UV lamp irradiates unpurified water. The lamp and the pump are turned off when the water is purified. A photocell placed near the UV lamp provides a signal to the electronic control unit. The electronic control unit may base the determination of whether the water is purified on a signal from the photocell, which is indicative of the purifying capability of the UV lamp The determination may be alternatively or further based on number of passes the water has made through the purification section, the type and level of impurities of the water placed in the tank,

In one embodiment, the utility unit has additional energy-drawing utilities such as a small refrigerator, an electrical receptacle, and/or light bulbs. Battery chargers for electronic devices such as cell phones and computers can be plugged into the receptacle. Televisions or radios can be powered from the receptacle. Lights can be integrated onto the utility unit or powered through the receptacle.

In one embodiment, an electronic control unit is provided to manage the energy collected during the day and stored in the battery or battery pack. The electronic control unit is supplied information concerning the priority energy-drawing utility. For example, for most households, ensuring that an adequate amount of drinking water is of highest priority. For another household, refrigerating life-saving drugs may be the top priority. In addition, the rank of the other utilities is also programmed into the electronic control unit. For example, in some situations, having a charged cell phone or laptop may be of the second highest priority after clean drinking water. In another situation, refrigeration is the second highest priority.

The electronic control unit estimates the amount of energy stored in the battery at the end of a day of solar collection. The electronic control unit estimates the energy that the priority energy-drawing utility will consume until the next insolation event (morning). If there is no excess energy, then no power is provided to non-priority utilities. If, however, there is excess energy, then the second highest priority utility will be allowed to operate. The electronic control unit continually makes this estimation. For example, it may be possible to operate lights for a period of time, e.g., while still having enough stored energy to purify the water in the tank. In one embodiment, the electronic control unit warns the user that the lights will be shut off, for example two minutes prior to power being cut off to the lights.

The electronic control unit, in one embodiment, may be used in combination with an electrical grid, e.g., an intermittent or unreliable electrical grid. In such applications, the utility unit has an electrical power input receptacle As the solar energy comes at no cost and the battery has a finite capacity to store energy, there is no reason to charge the battery off the electrical grid if there is sufficient insolation and time of insolation to fully charge the battery. Thus, when the electronic control unit detects that the utility unit is connected to the electrical grid and that the electrical grid is supplying electricity, the electronic control unit estimates the amount of energy that the battery needs to become fully charged and whether the solar energy being provided over the remaining hours of daylight is sufficient to fully charge the battery. If so, no energy, or alternatively, a modest amount of energy from the grid is provided to the batteries. In one embodiment, a safety factor is applied, meaning more energy from the grid is collected than strictly necessary. Such safety factor would take into account uncertainties such as cloud cover changing the insolation.

The present development provides many advantages. Those who must travel long distances for clean drinking water can purify local contaminated water. This allows more time for other activities such as education, employment, farming, etc. By drinking purified water, water-borne diseases will not be harbored in such individuals. The cost for such a unit is a one-time expenditure, as opposed to purification powered from a utility that charges. Such a unit according to the present development can also be used in developed countries in which a natural disaster interrupts delivery of potable water. Such a unit can provide potable water in times of floods, earthquakes, severe power outages, etc.

One obstacle to providing health care to those in remote and undeveloped parts of the world is that some medicines require refrigeration, which is not available to many people. Another advantage of the present development is that by providing a small refrigeration unit, life-saving medicines can be stored and remain effective.

Yet another advantage is that a modest amount of electrical energy can be made available to charge devices such as cell phones, laptops, medical monitoring equipment, etc. Furthermore, it can be used to power high-efficiency lighting, radios, etc. to information gathering, study, entertainment, as examples.

According to an embodiment of the present development, the amount of energy is managed to ensure that the highest priority utility is serviced. For example, if water purification is deemed the highest priority, then energy stored in the battery pack is monitored to ensure that the water is purified. This presents an advantage over partially purifying the water. According to another embodiment, the water is purified in a batch mode and if there is insufficient energy to purify all of the collected water, at least some potable water is provided. In the event that little solar energy is available, this presents an advantage that at least some potable water is available for drinking.

### BRIEF DESCRIPTION OF THE FIGURES

FIG. 1 is a electrical schematic of a utility unit according to an embodiment of the present development;

FIG. 2 is a side view of the utility unit in a housing according to an embodiment of the present development;

FIGS. 3 and 4 are hydraulic schematics of a water purification system according to embodiment of the present disclosure;

FIGS. 5 and 6 are flowcharts illustrating embodiments of the disclosure for managing energy among utilities in a utility unit;

FIG. 7 is a flowchart illustrating an embodiment of the disclosure for charging the battery according to an embodiment of the disclosure; and

FIG. 8 is an isometric drawing of an embodiment of the utility unit showing the utility unit in a state of partial assembly.

### DETAILED DESCRIPTION

As those of ordinary skill in the art will understand, various features illustrated and described with reference to any one of the Figures may be combined with features illustrated in one or more other Figures to produce embodiments that are not explicitly illustrated or described. The combinations of features illustrated provide representative embodiments for typical applications. However, various combinations and modifications of the features consistent with the teachings of this disclosure may be desired for particular applications or implementations.

An electrical and electronic schematic for a utility unit 10 is shown in

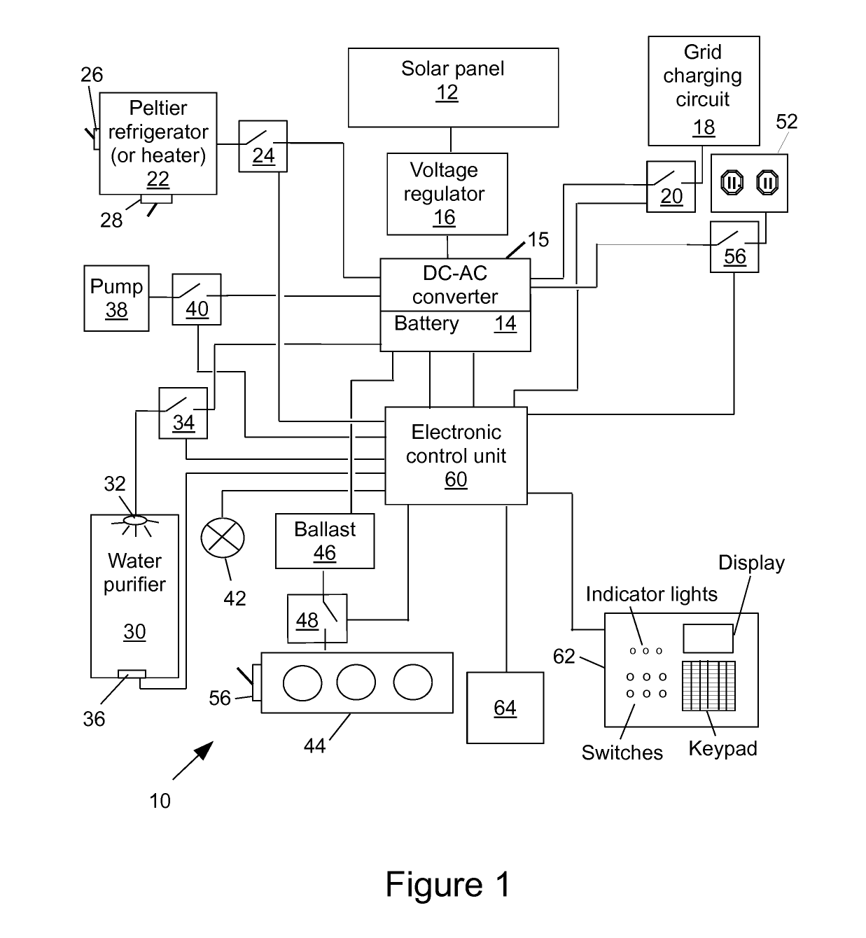

FIG. 1. Utility unit 10 has a solar panel 12 which is coupled to battery 14 (or battery pack) via a voltage regulator 16. In some applications, battery 14 can be charged via a grid charging circuit 18. As described above, in some locations, electrical power is available intermittently. By plugging into the grid, electrical energy collection can be supplemented by the grid when available. Switch 20 is provided so that electrical charging via the grid can be electronically controlled.

Utility unit 10 also has devices which are energy sinks, such as Peltier refrigerator 22, which has a switch 24 in between Peltier refrigerator 22 and battery 14. The switch is controlled electronically. Peltier refrigerator 22 has user operated switch 26 to turn off, e.g., when there is nothing that needs refrigerating to conserve electrical energy for other uses. Peltier refrigerator 22 can be a heater by switching its polarity; user-operated switch 28 is provided to switch between cooling and heating as desired.

A water purifier 30 is powered by battery 14. Water within water purifier 30 is purified by a UV lamp 32. An electronically-controlled switch 34 is provided between battery 14 and UV lamp 32. Because the intensity of UV lamp 32 varies from lamp to lamp and during the lifetime of a single lamp, in some embodiments, a photo sensor 36 is provided to ensure that sufficient UV irradiation has been applied to the water in water purifier 30. Water is circulated by pump 38 to water purifier 30. Power from battery 14 to pump 38 is controlled electronically by switch 40. In some embodiments, a valve 42 is provided to water purifier 30 (hydraulic connection of the water purifier system is discussed later in regards to FIGS. 3 and 4.

In one embodiment, utility unit 10 has lights 44, which are coupled to battery 14 via a ballast 46 and an electronically-control switch 48. A user-controlled switch 50 is coupled to lights 44.

In some embodiments, a receptacle 52 is coupled to battery 14 via a DC-AC converter 54 and an electronically-controlled switch 56.

The amount of energy stored in battery 14 is limited by: the area and efficiency of solar panel 12, the amount of electrical energy that can be obtained form the electrical grid, the amount of insolation available in a energy collecting session, or the energy storage capacity of battery 14. As the energy available is limited by one or more of the factors described above, the energy is managed, according to one embodiment, so that the most important utility is provided energy preferentially. Energy is managed by electronic control unit 60, which is coupled to battery 14 as well as switches 24, 34, 40, 48, and 56. If, for example, water purifier 30 is the preferred utility for a particular application, electronic control unit 60 determines whether there is enough energy stored in battery 14 to fully purify water in the system. If there is more than enough energy, then additional devices may be powered, possibly a secondary preferred utility or all other utilities that the user has switched on. After a period of time of such operation, it may be determined that the energy in battery 14 is enough to complete the water purification with no reserve. At this point, electronic control unit 60 would switch off switches 24, 48, and 56, i.e, those coupled to all utilities other than those associated with the water purifier system.

A communication panel 62 is coupled to electronic control unit 60.

State of charge of battery 14, which devices are operating, etc. can be output via indicator lights or a display device. Operator input via switches and/or a keyboard can be communicated to electronic control unit 60 via communication panel 62. As described above, utilities can be prioritized. The priority can be hardwired or programmed into electronic control unit 60. Alternatively, the priority can be programmed by the user through the keypad on communication panel 62. electronic control unit 60 may receive information from other sensors or control additional actuators, shown as other sensors/actuators 64 in FIG. 1.

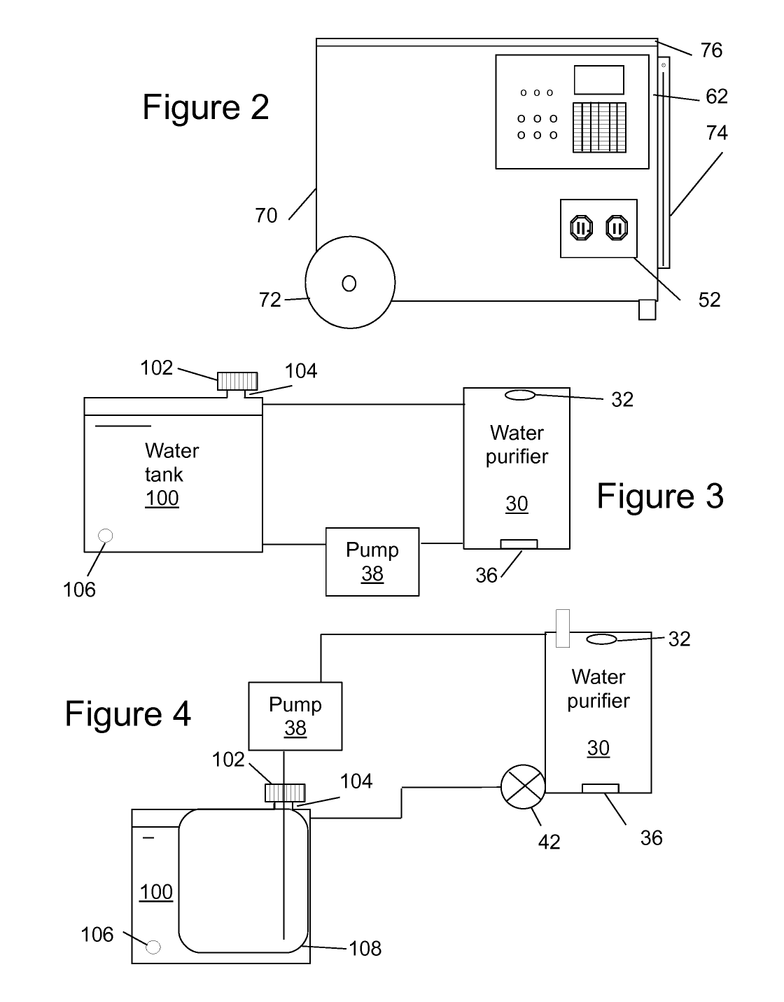

In FIG. 2, a housing 70 for the utility unit 10 is shown, which has wheels 72 and a handle 74. When handle 74 is lifted, the weight of the unit rests on the wheels and the unit can be transported. Housing 70 has a lid 76 to obtain access to the water purifier system and Peltier refrigerator within. Lid 76 may include a solar panel, possibly a folded solar panel, or solar panel can be separately deployed. Communication panel 62 and receptacle 52 are installed in housing 70 so that they are accessed from the exterior of housing 70.

An embodiment of a water purification system or water system is shown in FIG. 3. A water tank 100 has a cap 102 covering a fill spout 104. Water is removed from tank 100 via spigot 106. Water tank 100 is coupled via inlet and outlet pipes to water purifier 30 having UV lamp 32 and photo sensor 36. Water is circulated between water tank 100 by pump 38. Water is circulated through water purifier 30 until water in the system has been acted upon by sufficient UV light to purify the water. Not shown in the Figure, but a filter can be placed at fill spout 104 to collect debris such as organic material or dirt.

An alternative embodiment is shown in FIG. 4. Water tank 100 has cap 102, fill spout 104 and spigot 106. In this embodiment, however, a bladder 108 is supplied within tank 100 and coupled to fill spout 104. Unpurified water is placed within bladder 108, which can occupy essentially all the volume of tank 100. Water is drawn out of bladder 108 through cap 102 by pump 38 and supplied to water purifier 30 having UV lamp 32 and photo sensor 36. According to one alternative, water is purified in a batch mode with pump 38 filling purifier 30. After UV light is supplied for a sufficient period of time to purify the water in tank 100, valve 42 is opened , under control of the electronic control unit, and water flows by gravity from purifier 30 into tank 100. After the purified water has been pumped into tank 100, exterior to bladder 108, another batch of unpurified water is supplied to purifier 30. The process is repeated until bladder 108 is empty and tank 100 contains purified water on the outside of bladder 108. A port or air orifice 110 is provided on purifier 30 so that air initially in the purifier evacuates when the pump supplied unpurified water to purifier 30. Also, air enters purifier 30 when purified water leaves purifier 30. In one alternative, air orifice 110 may be closed either by a valve that is coupled to and controlled by the electronic control unit or by a float that closes off air orifice 110 when the level in purifier 30 is full or nearly full. In the embodiment shown in FIG. 4, water flows from purifier 30 to tank 100 by gravity. However, if a configuration is desired that doesn't support gravity feed, an additional pump may be provided in the tube between purifier 30 to tank 100. In such an embodiment, the additional pump may be used in place of valve 42, particularly if the additional pump is a positive displacement pump. In another alternative, valve 42 is a check valve that opens under pump pressure.

An advantage of the embodiment shown in FIG. 4 is that if there is insufficient energy stored in battery 14, at least some water is completely purified. In the embodiment in FIG. 3, if the energy stored is not sufficient to purify all the water, the contents of tank 100 is partially purified water.

In an alternative embodiment, a second tank is used in place of bladder 108. In such an embodiment, tank 100 is a first tank and holds the purified water. The second tank, a rigid container, is used to hold unpurified water. Another advantage of the embodiment shown in FIG. 4 and the alternative having two rigid tanks is that the tank to be filled with unpurified water can be readily disconnected from the other hardware for transport to the water source.

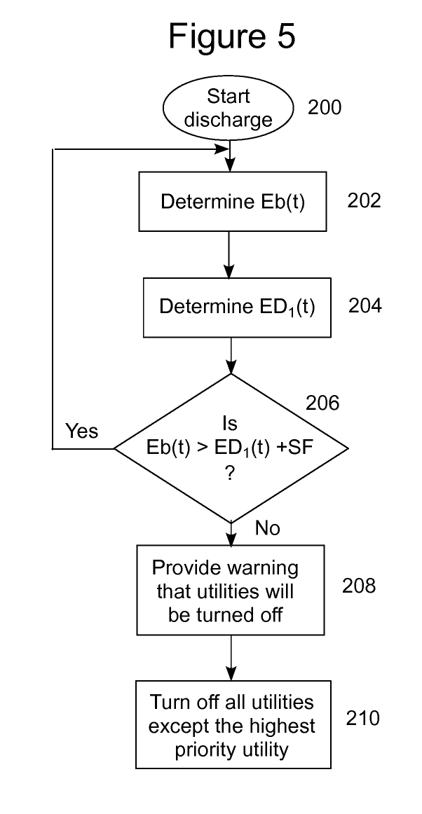

In FIG. 5, a flowchart relating to both a system and method according to embodiments of the present development is shown. Discharge of the battery starts at 200. The amount of energy stored in the battery, Eb(t), is determined in 202. The amount of energy that the highest priority utility will consume until a next charge cycle, ED1(t). is determined in 204. If the highest priority utility is water purification, the amount of purification that need yet be accomplished can be determined. If, however, the highest priority utility is refrigeration, the amount of energy required until a next recharge of the battery can be estimated. The next recharge can be a next sunrise. If the highest priority utility is for charging electronic devices, such as a cell phone, the amount of energy that will be withdrawn by the electronic devices can be learned over a number of days. Or, a maximum energy draw can be computed based on a present rate of energy usage. In 206, it is determined whether there is sufficient energy in the battery to provide the needs of the priority utility plus a safety factor to take into account uncertainties such as inaccuracies in the determination of Eb(t), ED1(t), etc. If the result is positive in 206, control returns to 202 to determine the current amount of energy stored in the battery. If the result is negative, then a warning is provided that utilities, other than the highest priority utility, will be turned off. In one embodiment, this is provided for such utilities as lights to give the operator an opportunity to stop what they are doing before the lights are turned off. Alternatively, a warning, light or sound signal, is given to indicate that any utility will be turned off. Shortly after the warning, the utilities, other than the highest priority utility, are turned off. This is accomplished by opening the switches that connect the utility with the battery.

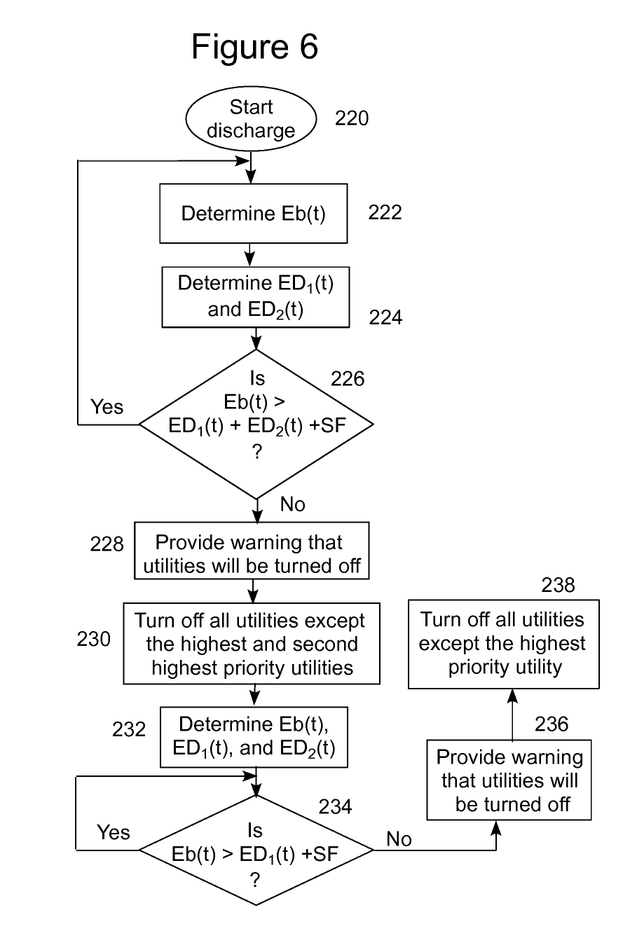

The method and system described in conjunction with FIG. 5 can be extended to have a hierarchy of utilities; an example of having a number one priority utility and a number two priority device and how to manage the energy stored in the battery is shown in FIG. 6. Discharge begins in 220. In 222 and 224, the energy stored in the battery (at the present time) and the amount of energy that the first and second priority devices are estimated to draw (from the present time until a next recharge of the battery) are determined, in any order. In 226, it is determined if there is enough energy stored in the battery so that both the draw by the first and second priority devices, ED1(t) and ED2(t) can be satisfied, with a safety factor additional amount of energy in the battery. If so, control returns to 222 and all the utilities are provided electrical power. If, however, a negative result occurs in block 226, a warning, optional, is given that all utilities will be turned off, except for the top two priority utilities. Shortly thereafter, the utilities are turned off in 230. In 232, energy stored in the battery and the estimated draws by the first and second priority utilities are determined or estimated. In 234, it is determined whether there the energy stored in the battery, at the present time, is enough to satisfy the draw of the first priority plus a safety factor. If a positive result, the test in 234 continues until a negative result, then a warning is provided in 236 that the second highest priority will be shut down. Shortly thereafter, in 238, the second highest priority utility is turned off.

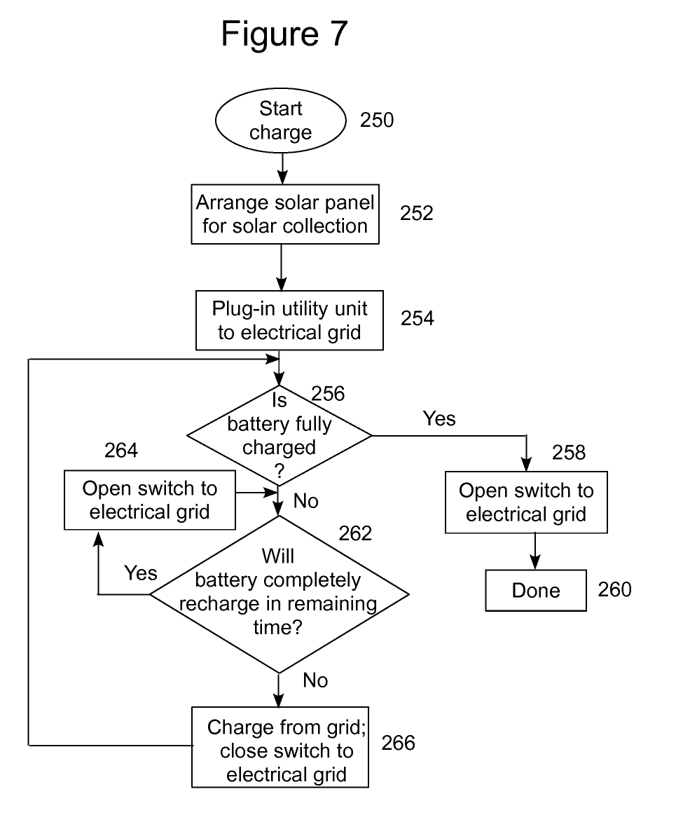

In FIG. 7, a method and system to determine when to use grid electricity is shown schematically. Charging is started in 250 when solar panel is arranged in 252. The method and system in FIG. 7 is applicable when grid electricity, albeit intermittent, is available. The utility unit is plugged into the electrical grid in 254. In 256, it is determined whether the battery is fully charged. If so, the switch to the electrical grid, switch 20 of FIG. 1, is opened and the routine is complete in 260. If in 256, the result is negative, whether there is enough insolation to fully charge the battery in the remaining time is estimated. If there is, the switch in the line coupling the electrical grid to the battery is opened. If in 262 there is not enough energy to fully charge the battery, charging from the grid is allowed in 266 by closing the switch (20 of FIG. 1) and allowing the grid to supplement the solar panel.

Because the utility unit is placed outdoors during the day to collect solar energy, the potential for theft is great. A physical restraint can be applied to the unit, such as locking it to a heavy object. Alternatively, the electronic control unit can be programmed to authenticate an authorized user. Although this doesn't prevent theft, it makes the unit unusable except to an authorized user. The electronic control unit has control over switches to the various utilities, eg., UV lamp, pump to water purifier, lights, AC receptacle, and Peltier refrigerator (or heater). The switches can be commanded to be open until an authorized user has been identified. The user may be identified by inputting a PIN to the keypad, inputting a password into the keypad, having a radio frequency identification tag in proximity to the electronic control unit, or by a biometric input, such as a retinal scan or a fingerprint scan. These are given by way of example and not intended to be limiting. Any known procedure for preventing theft known to one skilled in the art is contemplated by the inventor of the present development.

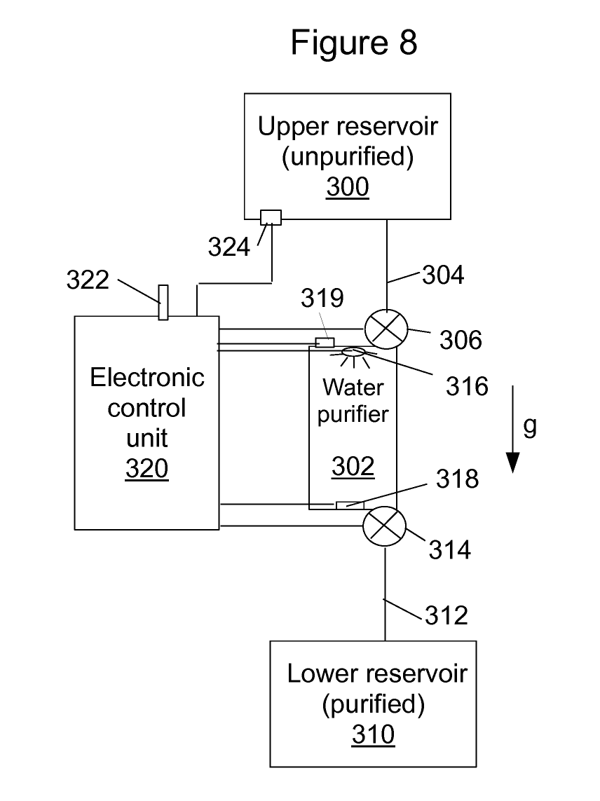

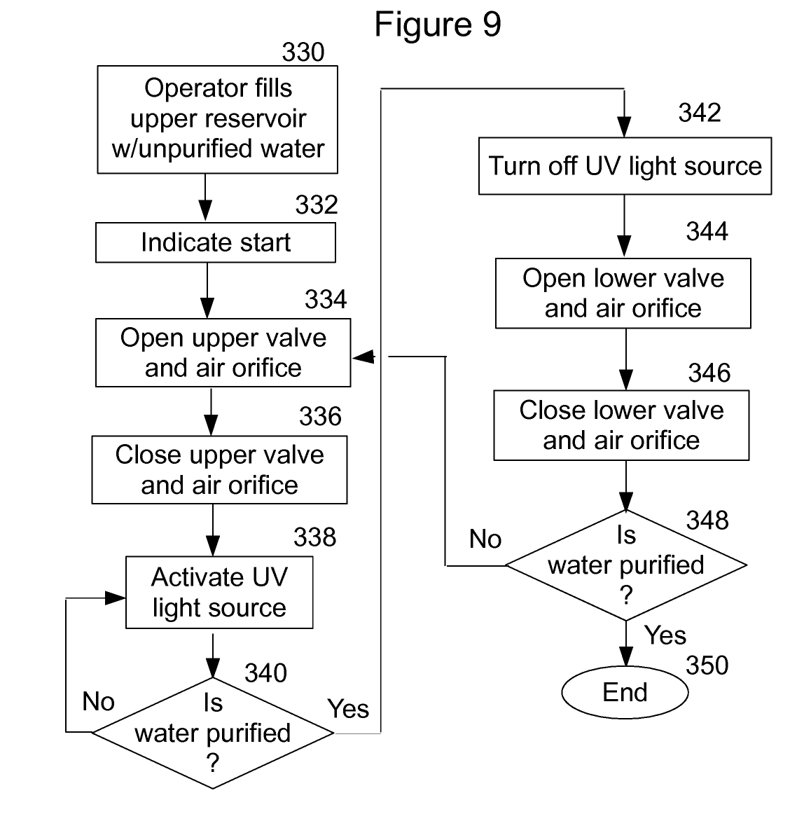

A gravity-feed embodiment is shown in FIG. 8 in which unpurified, possibly filtered, water is provided in an upper reservoir 300. Upper reservoir 300 is coupled to a water purifier 302 via a tube 304. An upper valve 306 is provided in tube 304. In the embodiment shown in FIG. 8, upper valve 306 is placed close to water purifier 302 to reduce a volume of fluid that can be held between valve 306 and water purifier 302. Water purifier 302 is coupled to a lower reservoir 306 via a tube 312 with a lower valve 314 in 312. Lower valve 314 is located close to water purifier 302 t reduce fluid holding capacity between valve 314 and water purifier 302. Water purifier 302 is provided with a UV light source 316 or other device for purifying water. In some embodiments, a light sensor 318 is provided. Light sensor 320 can be used to detect an amount of light from UV light source 316, the strength of which may vary due to aging of UV light source and/or voltage fluctuations. Alternatively, or additionally, light sensor 318 may be used to detect whether the water in water purifier 302 has been subjected to sufficient UV radiation to attain the desired purity. An air orifice 319 is provided near the top of water purifier 302. air orifice 319 is provided to evacuate air from water purifier 302 when filling is desired and to allow air to enter water purifier 302 when emptying is desired.

Also shown in FIG. 8 is an electronic control unit 320 connected to valves 306 and 314, UV light source 316, light sensor 318, and air orifice 319. In one embodiment, valves 306 and 314 are controlled by electronic control unit 320, as will be discussed below in regards to FIG. 9. Electricity to power electronic control unit 320, valve 306, valve 314, UV light source 316, UV sensor 318, etc. are provided by a battery (not shown), which has been charged via solar power and/or from the grid, depending on the embodiment. In some embodiments, a DC-to AC converter is provided to power AC devices. n another embodiment, all powered devices are DC devices obviating a DC-to-AC converter.

A flowchart showing one embodiment of operating the water purification system of FIG. 8 is shown in FIG. 9. In 330, the operator the system fills upper reservoir 300 with unpurified water. When the upper reservoir is filled and connected to the system, a start indication is determined in 332. Such start indication may be based on the operator depressing a button 322 indicating that the purification should be started. In an alternative, a sensor 324 indicates to electronic control unit 320 that upper reservoir 300 is full and ready for purification. Sensor 324 may be a float sensor such as is commonly provided in a fuel tank. Sensor 324 may be a weight sensor or any suitable sensor. Control passes to 334 when the start indication is received. In 334, upper valve 306 is opened. At about the same time, air orifice 319 is also opened. Air in water purifier 302 would delay water from upper reservoir 300 from entering water purifier 302. But, by opening air orifice 319, air within water purifier 302 escapes through air orifice 319 when water from upper reservoir 300 flows downward under the force of gravity (indicated by a g in FIG. 8). When water purifier 302 is full, which may be determined either by the passage of sufficient time or via sensor 324, upper valve 306 and air orifice 319 are closed in 336. In 338, UV light source 316 is activated. In 340, it is determined whether the water in water purifier 203 is sufficiently purified. This may be based on a period of time, a signal from light sensor 318, or any suitable technique. If not, UV light source 316 remains activated in 338. If yes in 340, control passes to 342 in which UV light source 316 is turned off. The purified water in water purifier 302 is emptied by opening lower valve 314 and air orifice 319. When water purifier 302 is empty, lower valve 314 and air orifice 319 are closed in 346. In 348, it is determined whether upper reservoir is empty. If so, the procedure ends in 350. If upper reservoir 300 is not empty, control passes to 334 to purify an additional batch of water. Although not explicitly shown, upper reservoir 300 and lower reservoir 310 may be provided with an air orifice, which can be opened/closed under control of electronic control unit 320. Alternatively, a small, open orifice is provided. Such an orifice that is always open is suitable for upper reservoir 300. However, it may be useful to provide an orifice that can be closed, either under electronic control or by mechanical means, to avoid overfilling of water purifier 302 and/or lower reservoir 310 and dumping water due to gravity pushing water out of the orifice.

Volume of upper reservoir 300 and volume of lower reservoir 310 are both greater than the volume of water purifier 302. This provides advantages in that the water is purified in multiple batches. Thus, if there is insufficient electricity stored in the battery to purify all of the water, at least one or several batches are purified to provide some drinking water. In an alternative system in which a UV lamp acts upon all of the water in a tank, the water may be only partially purified leaving no potable water. Also, by processing the water in batches, the volume and shape of the water purifier can be optimized for efficient purification rather than having to compromise performance to have the UV lamp attempting to purify a tank of a desired volume. According to embodiments of the present disclosure, a large volume of water can be purified, but in batches. Another advantage is that by having an electronic controller, the purification can occur unintended after the unpurified water is provided to the tank and the process is initiated.

According to an embodiment, a method and system are disclosed to control a utility unit. The utility unit includes: a battery, a solar collector electrically coupled to the battery, a first energy-drawing utility, a second energy-drawing utility, and an electronic control unit electronically coupled to the first and second utilities to manage battery energy. An amount of energy stored in the battery is estimated. A first energy draw by the first utility until a next battery charging event is also estimated. A switch disposed in the electrical line connecting the second utility to the battery is opened when the estimated amount of energy stored in the battery is less the first energy draw plus a predetermined amount. The predetermined amount is a safety factor. The first utility is designated a preferred utility and such designation is selectable.

According to the method, a warning indication that power is to be switched off can be provided a predetermined time prior to opening the switch to the second utility with the indication being at least one of a light and a sound. In one embodiment, switches to all utilities are opened until an authorized user of the utility unit has been identified. The authorized user is identified by one of: typing an authorized personal identification number into a keypad coupled to an electronic control unit electronically coupled to the utility unit, typing an authorized password into the keypad, having an authorized radio frequency identification chip within proximity of the electronic control unit, and an authorized biometric identification.

Additional advantages and modifications will occur to those skilled in the art. Therefore, the present disclosure in its broader aspects is not limited to the specific details and representative embodiments shown and described herein. Accordingly, various modifications may be made without departing from the spirit or scope of the general inventive concept as defined by the appended claims and their equivalents.

I claim:

1. A utility unit, comprising:
a battery;
a solar collector electrically coupled to the battery;
a water purification system comprising:
a water tank for purified water;
a reservoir for unpurified water;
a water purifier having a UV lamp;
a first tube coupled between the water tank and the water purifier;
a second tube coupled between the water purifier and the reservoir; and
an electric pump disposed in one of the two tubes for circulating water between the water tank and the water purifier wherein the electric pump is electrically coupled to the battery; and
an electronic control unit electronically coupled to the pump to control flow through the water purification system.

2. The utility unit of claim 1 wherein the reservoir for unpurified water is one of:
a bladder disposed within the water tank for purified water; and
a tank for unpurified water.

3. The utility unit of claim 1, further comprising:
a grid charging circuit electrically coupled to the battery via a grid switch wherein the grid charging circuit adapted to be coupled to an external AC power source and the grid switch is electronically coupled to the electronic control unit.

4. The utility unit of claim 3 wherein the electronic control unit estimates an amount of battery charging capability from the solar collector prior to a next sunset and when the amount is insufficient to fully charge the battery prior to sunset and causes the battery to be charged off the grid.

5. The utility unit of claim 1, further comprising:
a refrigerator electrically coupled to the battery and electronically coupled to the electronic control unit wherein the refrigerator has an insulated cavity and a selectively openable cover.

6. The utility unit of claim 1, further comprising:
a DC-AC converter coupled to the battery; and
an AC receptacle coupled to the converter, the AC receptacle adapted to charge electronic devices external to the utility unit.

7. The utility unit of claim 1 wherein the water purifier is a first energy drawing utility, the utility unit further comprising:
a second power drawing utility wherein the electronic control unit is electronically coupled to the first and second energy drawing utilities, one of the first and second utilities is designated a priority utility and the other is designated a non-priority utility, and the electronic control unit turns off power to the non-priority utility when the electronic control unit estimates that an amount of energy stored in the battery less than an amount of energy estimated to be consumed by the priority utility until a next charging event.

8. The utility unit of claim 7 wherein designation of the priority and non-priority utilities is selectable.

9. The utility unit of claim 1, further comprising:
a valve disposed in the second tube wherein the electronic control unit commands a batch purification by:
commanding the pump to pump water from the tank into the water purifier;
turning on the UV lamp to purify the water in the water purifier;
commanding the valve to open when the water in the water purifier is sufficiently purified; and
commanding the valve to close when the water in the purifier has drained into the water purifier.

10. The utility unit of claim 9, further comprising:
a light sensor coupled to the water purifier and electronically coupled to the electronic control unit wherein the electronic control unit determines that the water in the water purifier is purified based on one of a signal from the light sensor and elapse of a predetermined time.

11. The utility unit of claim 1, further comprising: a theft prevention device within the electronic control unit, wherein the electronic control unit deactivates at least one of an AC receptacle coupled to the battery, a light coupled to the battery, the pump, and a refrigeration coupled to the battery in response to identifying theft.

12. The utility unit of claim 1, further comprising: a user-identification routine within the electronic control unit, wherein the electronic control unit deactivates at least one of an AC receptacle coupled to the battery, a light coupled to the battery, the pump, and a refrigeration coupled to the battery until a user can provide one of: a personal identification number, a password, a biometric match to information stored in the electronic control unit, and a radio frequency identification tag which communicated with the electronic control unit to authenticate the user.

13. A method to control a utility unit wherein the utility unit comprises: a battery; a solar collector electrically coupled to the battery; a first energy-drawing utility; a second energy-drawing utility; and an electronic control unit electronically coupled to the battery and the first and second utilities to manage energy stored in the battery, the method comprising:
estimating an amount of energy stored in the battery;
estimating a time for a next charging event;
estimating a first energy draw by the first utility until the next charging event; and
switching off power to the second energy-drawing utility when the first energy draw exceeds the estimated energy stored in the battery.

14. The method of claim 13 wherein the first utility is designated a preferred utility and the second utility is designated a non-preferred utility.

15. The method of claim 13 wherein the first utility is a water purifier coupled to the battery and the second utility is one of a refrigerator, an AC electrical outlet, and a light.

16. The method of claim 13 wherein the utility unit comprises a third energy-drawing utility, the method further comprising:
estimating a second energy draw by the second utility until the next charging event; and
switching off energy supply to the third energy-drawing utility when the sum of the first and second utilities exceeds the estimated energy stored in the battery.

17. A purification system, comprising:
an upper reservoir;
a purifier coupled to the upper reservoir by a first tube with an upper valve between the purifier and the upper reservoir; and
a lower reservoir coupled to the purifier by a second tube with a lower valve between the purifier and the lower reservoir wherein:
a lowest portion of the upper reservoir is located above a highest portion of the purifier;
a highest portion of the lower reservoir is located below a lowest portion of the purifier; and
a volume of the purifier is substantially less than a volume of both a volume of the upper reservoir and a volume of the lower reservoir.

18. The purification system of claim 17, further comprising:
an electronic control unit coupled to the upper valve and the lower valve for controlling opening and closing of the upper and lower valves wherein the electronic control unit commands the upper valve to open when flow from the upper reservoir to the purifier is indicated and the electronic control unit commands the lower valve to open when flow from the purifier to the lower reservoir is indicated.

19. The purification system of claim 17 wherein the purifier has a UV lamp, the system further comprising:
a battery providing electrical power to the UV lamp, the upper valve, and the lower valve;
an electronic control unit electronically coupled to the UV lamp, the upper valve, and the lower valve wherein the electronic control unit commands the upper valve to open to allow flow from the upper reservoir to the purifier, the electronic control unit activates the UV lamp when the purifier contains unpurified liquid, and the electronic control unit command the lower valve to open to allow flow from the purifier to the lower reservoir.

20. The purifier of claim 17 wherein the purifier has a UV lamp, the system further comprising:
a battery providing electrical power to the UV lamp, the upper valve, and the lower valve;
a solar collector coupled to the battery.
